(19) United States
(12) Patent Application Publication
(10) Pub. No.: US 2026/0192932 A1
(43) Pub. Date: Jul. 9, 2026

(54) PROPULSION UNIT WITH LONGITUDINAL BLOCKING OF AT LEAST ONE NACELLE COWL

(71) Applicant: Safran Nacelles, Gonfreville L'orcher (FR)

(72) Inventors: Romain GARDEL, Moissy Cramayel (FR); François BELLET, Moissy Cramayel (FR); Pascal SOULIER, Moissy Cramayel (FR); Sylvain BERNARD, Moissy Cramayel (FR)

(73) Assignee: Safran Nacelles, Gonfreville L'orcher (FR)

(21) Appl. No.: 19/556,733

(22) Filed: Mar. 4, 2026

Related U.S. Application Data
(63) Continuation of application No. PCT/FR2024/051173, filed on Sep. 6, 2024.

(30) Foreign Application Priority Data
Sep. 7, 2023 (FR) 23/09409

(51) Int. Cl. B64D 29/06; B64D 27/10; B64D 27/40; B64D 29/08

(52) U.S. Cl. CPC B64D 29/06; B64D 27/10; B64D 27/402; B64D 29/08

(57) ABSTRACT

A propulsion assembly for an aircraft includes a turbine engine, a nacelle having a section provided with at least one cover that is movably mounted so as to deploy between a working position and a maintenance position for the purpose of providing access to a turbine engine, a pylon that attaches the turbine engine and/or the nacelle to the aircraft, a longitudinal locking mechanism including, for each cover, a finger and a sleeve provided with two retaining portions extending transversely to the corresponding longitudinal axis. The finger is configured to be guided between the two retaining portions in the maintenance position. The sleeve is attached to the corresponding cover or to an element connected to the corresponding cover, and the finger is attached to the pylon, or vice versa.

### CROSS-REFERENCE TO RELATED APPLICATIONS

This application is a continuation of International Application No. PCT/FR2024/051173, filed on September 6, 2024, which claims priority to and the benefit of FR 23/09409 filed on September 7, 2023. The disclosures of the above applications are incorporated herein by reference.

### FIELD

The present disclosure relates to a propulsion unit comprising a longitudinal blocking mechanism of at least one nacelle cowl.

### BACKGROUND

The statements in this section merely provide background information related to the present disclosure and may not constitute prior art.

It is known to have a propulsion unit comprising a nacelle with a cross-section provided with two generally hemispherical half-shells on either side of a longitudinal plane of symmetry of the nacelle, the plane being generally vertical.

Typically, the two half-shells can be part of a thrust reverser. Furthermore, each half-shell is movably mounted between a working position and a maintenance position intended to provide access to the turbomachine.

The working position corresponds to the closed position adopted in flight. The maintenance position corresponds to an open position that allows access to the turbomachine or turbojet engine from outside the nacelle.

Each half-shell is pivotally mounted about a corresponding longitudinal axis extending from the upper part of the nacelle, that is to say at a clockwise position close to 12 o'clock.

The operating constraints of the half-shells can cause an offset of the half-shells relative to the remainder of the nacelle along the longitudinal axis during position changes between the working position and the maintenance position.

However, this longitudinal offset is to be avoided because the half-shells may fail to return to their correct position when closed. This offset can lead to negative consequences such as mechanical damage at the points of contact with the remainder of the nacelle and the displacement of the half-shells in flight.

Document FR 2920141 A1 proposes blocking means to prevent this longitudinal offset. Each half-shell comprises blocking means cooperating in the maintenance position with complementary blocking means arranged on a fixed frame of the turbomachine. This solution is satisfactory in that the offset is avoided by maintaining the alignment in the maintenance position.

However, the proposed solution limits the opening angle between the working position and the maintenance position due to the bulk of the blocking means.

### SUMMARY

This section provides a general summary of the disclosure and is not a comprehensive disclosure of its full scope or all of its features.

The present disclosure aims to resolve all or part of the drawbacks mentioned above.

To this end, the present disclosure concerns a propulsion unit for an aircraft comprising: a nacelle having a cross-section provided with at least one cowl movably mounted so as to be deployed between a working position and a maintenance position to provide access to a turbomachine intended to be mounted in the nacelle, a pylon adapted to fasten the turbomachine and/or the nacelle to the aircraft; the pylon comprising, for each cowl, a first hinge portion configured to cooperate with a second hinge portion of the corresponding cowl so as to allow the pivoting of the cowl about a corresponding longitudinal axis between the working position and the maintenance position; a longitudinal blocking mechanism comprising, for each cowl, a finger and a sleeve having two retaining portions extending transversely to the corresponding longitudinal axis, the finger being configured to be guided between the two retaining portions in the maintenance position; the finger and the sleeve being configured to describe a relative trajectory along a circular arc about the corresponding longitudinal axis between the working position and the maintenance position; the sleeve being attached to the corresponding cowl or a connecting element to the corresponding cowl and the finger being attached to the pylon, or vice versa.

According to one aspect of the present disclosure, the propulsion unit comprises two cowls. Due to their respective locations, secured to the cowls on one side and secured to the pylon on the other side, the fingers and sleeves of the longitudinal blocking mechanism authorize for a significant opening angle between the working position and the maintenance position.

Indeed, the length of the stroke between a cowl and the pylon can be defined by the radius of the circular arc described by the stroke. It is therefore easy to increase the angle between the working position and the maintenance position while still benefiting from the longitudinal blocking.

For example, the finger is not engaged in the sleeve in the working position of the cowl.

According to one aspect of the present disclosure, the sleeve is a projecting element attached to the cowl or the corresponding connecting element.

This arrangement allows the cowl to be axially recentered. During closing, the cowl is re-engaged with the corresponding parts of the nacelle and the turbomachine. Thus, there is no axial offset between the cowl, the remainder of the nacelle, and the turbomachine in the working position after closing.

In one aspect, the propulsion unit includes the turbomachine.

According to one aspect of the present disclosure, each cowl is a half-shell of generally hemispherical shape. In one aspect, the cowls extend on either side of a longitudinal plane of symmetry of the nacelle. In particular, this plane is vertical. Alternatively, this plane can be horizontal, for example, for the business aircrafts.

According to one aspect of the present disclosure, for each cowl, the finger and the sleeve are configured to be spaced apart from the longitudinal axis between the working position and the maintenance position.

This arrangement makes it possible to define the arc of a circle at a position more or less distant from the longitudinal axis. It is thus possible, by means of the size of the finger and of the sleeve, to define the maximum opening angle of the cowls in the maintenance position.

This maximum angle is therefore greater than what is possible with a longitudinal blocking mechanism located at the hinge, that is to say, located at the longitudinal axis.

According to one aspect of the present disclosure, for each cowl, the finger and the sleeve extend at least partially in a curved manner along the trajectory of the circular arc about the longitudinal axis so that the finger and the sleeve interlock within each other between an intermediate position and the maintenance position.

This arrangement makes it possible to define a first step of transition from the working position to the intermediate position in which the finger and the sleeve do not cooperate, that is to say are spaced apart from one another, and a second step of cooperation between the intermediate position and the maintenance position.

By sizing and positioning the finger and the corresponding sleeve, it is thus possible to define the cowl opening angle from which the finger and the sleeve begin to cooperate.

The finger can have a dimension greater or less than a quarter circle according to the sleeve's position.

According to one aspect of the present disclosure, for each cowl, the finger has, on either side, transverse to the longitudinal axis and relative to a direction of airflow in the propulsion unit, an upstream cooperation face and a downstream cooperation face configured to cooperate with the sleeve. The upstream cooperation face and/or the downstream cooperation face provide, respectively, at one end of the finger, an upstream engagement chamfer and/or a downstream engagement chamfer configured to engage the finger in the sleeve in case of offset along the longitudinal axis.

The upstream engagement chamfer and/or the downstream engagement chamfer make it possible to compensate for any offset along the longitudinal axis of the cowl during opening. Thus, in the intermediate position, in case of offset, the upstream engagement chamfer or the downstream engagement chamfer cooperates with the sleeve, and the offset is reduced and then eliminated as the cowls move towards the maintenance position.

This arrangement makes it possible therefore to ensure that there is no offset along the longitudinal axis of the cowls in the maintenance position. Moreover, even if an offset appears before the intermediate position, the upstream engagement chamfer or the downstream engagement chamfer makes it possible to ensure that the fingers retract correctly into their respective sleeves and that the offset is eliminated.

Thus, when the cowls move back from the maintenance position to the working position, there is no offset along the longitudinal axis, and the cowls correctly return to their working positions.

Moreover, the fact that the finger and the sleeve are located at a distance from the longitudinal axis and describe a circular arc trajectory makes it possible to provide downstream and upstream engagement chamfers that are only slightly pronounced. Friction is thus limited during the transition from the intermediate position to the maintenance position.

According to one aspect of the present disclosure, for each cowl, the sleeve has two parallel surfaces extending transversely to the longitudinal axis, the two parallel surfaces being configured to cooperate respectively with the upstream cooperation face and the downstream cooperation face.

The sleeve is therefore a simple part in design and easy to manufacture. The parallel surfaces can be flat and cooperate with parallel flat portions of the upstream cooperation face and the downstream cooperation face contiguous to the upstream engagement chamfer and downstream engagement chamfer, respectively.

As an alternative to two parallel surfaces, each sleeve can comprise two rollers freely rotatable about axes transverse to the direction of insertion of the finger between the rollers. This alternative makes it possible to reduce friction.

According to one aspect of the present disclosure, for each cowl, the sleeve comprises two distinct studs defining an intermediate space extending along the longitudinal axis and adapted to receive the finger by shape complementarity.

This arrangement facilitates the construction of the sleeve, which is simple in shape with two spaced-apart studs. Moreover, the intermediate space corresponds to the width of the finger along the longitudinal axis, within functional clearances.

According to one aspect of the present disclosure, each cowl comprises a beam extending parallel to the corresponding longitudinal axis, the second hinge portion being attached to the beam on one side, and the sleeve or the finger being attached to the beam on the other side so as to be spaced from the second hinge portion along the corresponding longitudinal axis.

This arrangement allows easier access to the longitudinal blocking mechanism, the latter being spaced from the hinge along the corresponding longitudinal axis.

According to one aspect of the present disclosure, the sleeve or the finger is attached to an extension of the corresponding beam or to the connecting element itself attached to the beam.

The sleeve or the finger can be fastened to the extension or the connecting element by rivets. The sleeve can also be manufactured as a single piece attached to the extension or the connecting element.

According to one aspect of the present disclosure, the propulsion unit further comprises, for each cowl, a shim device configured to be inserted between the finger and the pylon and/or between the sleeve and the corresponding cowl, or vice versa; the shim device being configured to adjust the position of the finger and/or the sleeve along the longitudinal axis.

It is thus possible to displace the finger or the sleeve along the longitudinal axis so as to align them according to the existing functional clearances between the turbomachine, the nacelle, and the cowl.

According to one aspect of the present disclosure, for each cowl, the shim device comprises a ridged shim configured to be mounted on the corresponding pylon or the cowl, the ridged shim having a plurality of ridges positioned perpendicular to the longitudinal axis so as to allow a cooperation with the finger or the sleeve in a plurality of axially adjusted positions.

This arrangement allows the axial position of the finger and/or the sleeve to be adjusted by offsetting one or more ridges to provide proper alignment of the finger and the sleeve in the maintenance position.

According to one aspect of the present disclosure, the shim device comprises, alternatively or additionally, a plurality of interchangeable shims suitable for being arranged on either side of a mounting support of the finger or the sleeve on the corresponding pylon or cowl, the interchangeable shims are configured to be arranged in varying quantities on either side of the mounting support to adjust the position of the finger or the sleeve along the longitudinal axis.

For example, the mounting support may be the cowl extension or the connecting element to the cowl for securing the sleeve, particularly at two points corresponding to the two studs.

According to one aspect of the present disclosure, each cowl has a semi-circumferential tooth extending in a plane transverse to the corresponding longitudinal axis, the semi-circumferential tooth being configured to cooperate with a corresponding groove of the turbomachine in the working position and up to a release opening angle of the cowl.

This arrangement allows guiding the cowls at the beginning of the opening. In one aspect, for each cowl, the fingers and sleeves do not cooperate in the working position.

According to one aspect, the semi-circumferential tooth has a downstream stop extending substantially orthogonally to the corresponding longitudinal axis and an upstream stop extending at an angle to the downstream stop so as to define a point.

The constraints on the cowl during opening are directed downstream. The orthogonal downstream stop thus allows maintaining the cowl’s alignment between the working position and the release opening angle.

According to one possibility, the release opening angle is less than the cowl’s angle in the intermediate position. In this case, the cowl is free of constraint between these two opening angles.

According to one possibility, the release opening angle is greater than the cowl’s angle in the intermediate position. In this second case, the cowl is doubly constrained between these two opening angles. This overlap inhibits any movement of the cowl along its longitudinal axis.

According to one aspect of the present disclosure, the propulsion unit comprises, for each cowl, an additional blocking guide provided with a channel formed in a casing of the turbomachine or the corresponding cowl, and an arm attached to the cowl or the casing configured to cooperate with the channel so as to inhibit translation of the cowl along its corresponding longitudinal axis relative to the casing between a first opening angle of the cowl less than the release opening angle and a second opening angle greater than an intermediate angle at the start of cooperation between the finger and the corresponding sleeve.

Each cowl is first maintained by the semi-circumferential tooth, then by the blocking guide, and finally by the longitudinal blocking mechanism.

The additional blocking guide is thus an axial blocking element allowing to maintain the cowls axially between the retention by the semi-circumferential tooth and the retention by the longitudinal blocking mechanism.

Moreover, there is an overlap between these three longitudinal blocking means so as to inhibit any longitudinal offset.

According to one aspect of the present disclosure, the longitudinal blocking mechanism engages at a cowl opening angle relative to the longitudinal axis of approximately 10°.

The different aspects defined above, which are not incompatible, can be combined.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a detailed perspective view of a propulsion unit for an aircraft comprising a longitudinal blocking mechanism.

FIG. 2 is a perspective view of the longitudinal blocking mechanism.

FIG. 3 is a schematic cross-sectional view of the longitudinal blocking mechanism.

FIG. 4 is a schematic cross-sectional view of a variant of the longitudinal blocking mechanism.

FIG. 5 is a top view of the longitudinal blocking mechanism.

FIG. 6 is a schematic cross-sectional view of a shim device of the longitudinal blocking mechanism.

FIG. 7 is a schematic cross-sectional view of a variant of the shim device for the longitudinal blocking mechanism.

FIG. 8 is a schematic cross-sectional view of the propulsion unit.

FIG. 9 is a perspective view of the propulsion unit in the working position.

FIG. 10 is a perspective view of the propulsion unit in the maintenance position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the detailed description that follows of the figures defined above, the same elements or elements performing identical functions may retain the same reference numerals in order to simplify the understanding of the present disclosure.

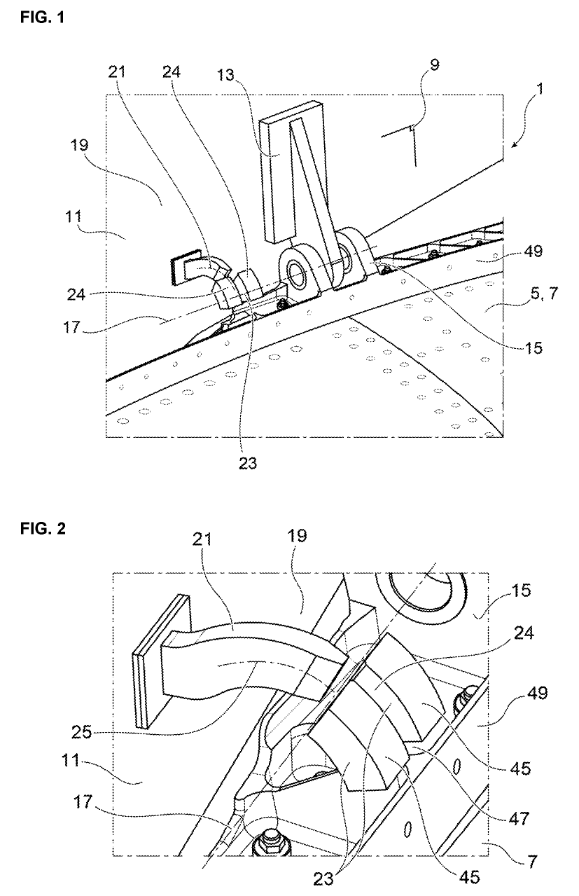

As illustrated in FIGS. 1 to 4 and 8, a propulsion unit 1 for aircraft comprises a turbomachine 3, a nacelle 5 having a cross-section provided with two cowls 7 or half-shells of generally hemispherical shape on either side of a longitudinal vertical plane of symmetry 9 of the nacelle 5.

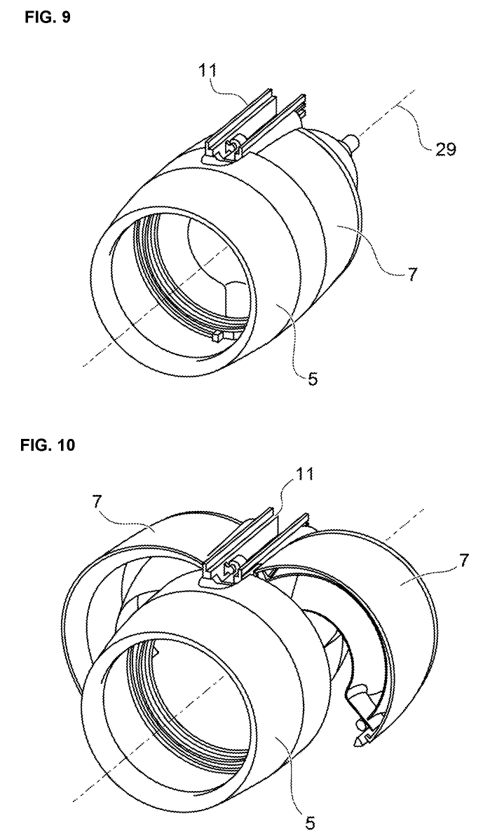

As illustrated in FIGS. 9 and 10, each cowl 7 is movably mounted so as to be deployed between a working position and a maintenance position in order to provide access to the turbomachine 3.

Although a propulsion unit 1 with a cowled turbomachine 3 is illustrated, the present disclosure would be applicable to a propulsion unit 1 with an un-cowled turbomachine 3.

The propulsion unit 1 comprises a pylon 11 adapted for fastening the turbomachine 3 and/or the nacelle 5 to a wing and/or fuselage of the aircraft.

The pylon 11 comprises, for each cowl 7, a first hinge portion 13 configured to cooperate with a second hinge portion 15 of the corresponding cowl 7 so as to allow the cowl 7 to pivot about a corresponding longitudinal axis 17 between the working position and the maintenance position.

The propulsion unit 1 comprises a longitudinal blocking mechanism 19 comprising, for each cowl 7, a finger 21 and a sleeve 23 having two retaining portions 24 extending transversely to the corresponding longitudinal axis 17, the finger 21 being configured to be guided between the two retaining portions 24 in the maintenance position.

The finger 21 and the sleeve 23 are configured to describe a relative trajectory along a circular arc 25 about the corresponding longitudinal axis 17 between the working position and the maintenance position.

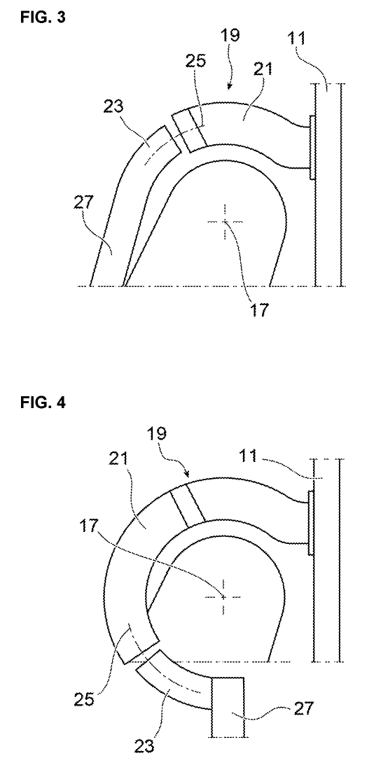

The sleeve 23 is attached to the corresponding cowl 7 or a connecting element 27 to the corresponding cowl 7, and the finger 21 is attached to the pylon 11. FIGS. 3, 4, and 7 show the connecting element 27, while these elements have not been shown in the other figures to simplify the views.

Moreover, the finger 21 and the sleeve 23 are interchangeable while maintaining the same function. The finger 21 could be attached to the corresponding cowl 7 or the corresponding connecting element 27, and the sleeve 23 to the pylon 11.

For each cowl 7, the finger 21 and the sleeve 23 are configured to be spaced along the longitudinal axis 17 between the working position and the maintenance position.

The finger 21 and the sleeve 23 extend at least partially in a curved manner along the trajectory of the circular arc 25 about the longitudinal axis 17, such that the finger 21 and the sleeve 23 are interlocked between an intermediate position and the maintenance position.

This defines a first step of transition from the working position to the intermediate position, in which the finger 21 and the sleeve 23 do not cooperate, and a second step of cooperating between the intermediate position and the maintenance position.

By sizing and positioning the finger 21 and the corresponding sleeve 23, it is thus possible to define the opening angle of the cowl at which the finger 21 and the sleeve 23 begin to cooperate.

As illustrated in FIGS. 3 and 4, which represent alternative variations, the finger 21 can have a dimension greater than or less than a quarter circle, depending on the position of the sleeve 23.

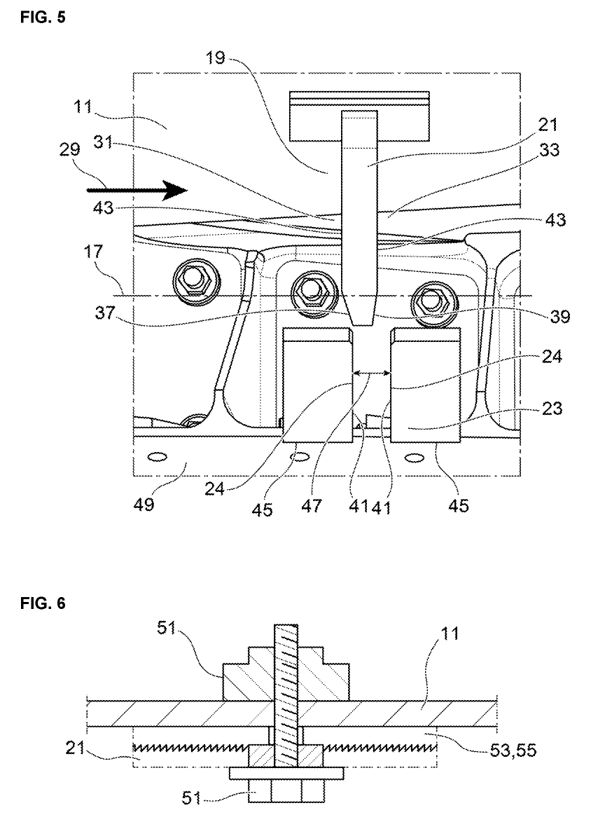

As illustrated in FIG. 5, the finger 21 has, on either side, transverse to the longitudinal axis 17 and relative to a direction of airflow 29 in the propulsion unit 1, an upstream cooperation face 31 and a downstream cooperation face 33 configured to cooperate with the sleeve 23.

The upstream cooperation face 31 and the downstream cooperation face 33 respectively provide, at one end of the finger 21, an upstream engagement chamfer 37 and a downstream engagement chamfer 39 configured to engage the finger 21 in the sleeve 23 in case of offset along the longitudinal axis 17.

The upstream engagement chamfer 37 and the downstream engagement chamfer 39 allow to compensate for an offset along the longitudinal axis 17 of the corresponding cowl 7 during opening. Thus, in the intermediate position, in case of offset, the upstream engagement chamfer 37 or the downstream engagement chamfer 39 cooperate with the sleeve 23 and the offset is reduced and then eliminated as it moves towards the maintenance position.

This arrangement makes it possible therefore to ensure that there is no offset along the longitudinal axis 17 of the cowls 7 in the maintenance position. Moreover, even if an offset appears before the intermediate position, the upstream engagement chamfer 37 or the downstream engagement chamfer 39 makes it possible to ensure that the fingers 21 enter correctly into their respective sleeves 23 and that the offset is eliminated.

Thus, when the cowls 7 move again from the maintenance position to the working position, there is no offset along the longitudinal axis 17 and the cowls 7 correctly return to their working positions.

Moreover, the fact that the finger 21 and the sleeve 23 are at a distance from the longitudinal axis 17 and describe a circular arc trajectory 25 allows for slightly pronounced downstream 39 and upstream 37 engagement chamfers. The friction is thus limited during the transition from the intermediate position to the maintenance position.

The sleeve 23 has two parallel surfaces 41 extending transversely to the longitudinal axis 17, the two parallel surfaces 41 being configured to cooperate respectively with the upstream cooperation face 31 and the downstream cooperation face 33.

The parallel surfaces 41 can be planar and cooperate with parallel planar portions 43 of the upstream cooperation face 31 and the downstream cooperation face 33 contiguous respectively to the upstream engagement chamfer 37 and the downstream engagement chamfer 39.

Alternatively, to the two parallel surfaces 41, each sleeve 23 can comprise two rollers free to rotate about axes transverse to the direction of insertion of the finger 21 between the rollers.

As illustrated in FIGS. 1 to 5, the sleeve 23 comprises two distinct studs 45 creating an intermediate space 47 extending along the longitudinal axis 17 and adapted for the insertion of the finger 21 by shape complementarity.

The intermediate space 47 corresponds to the width of the finger 21 along the longitudinal axis 17, within functional clearances.

Each cowl 7 comprises a beam 49 extending parallel to the corresponding longitudinal axis 17, the second hinge portion 15 being attached to the beam 49 on one side and the sleeve 23 being attached to the beam 49 on the other so as to be spaced apart from the second hinge portion 15 along the corresponding longitudinal axis 17.

This arrangement allows easier access to the longitudinal blocking mechanism 19, which is spaced apart from the hinge along the corresponding longitudinal axis 17.

The sleeve 23 is attached to a corresponding extension of the beam 49 or to the connecting element 27, itself attached to the beam 49.

The sleeve 23 can be fixed to the extension or to the connecting element 27 by rivets or screws 51. The sleeve 23 can also be manufactured as a single piece attached to the extension or to the connecting element 27.

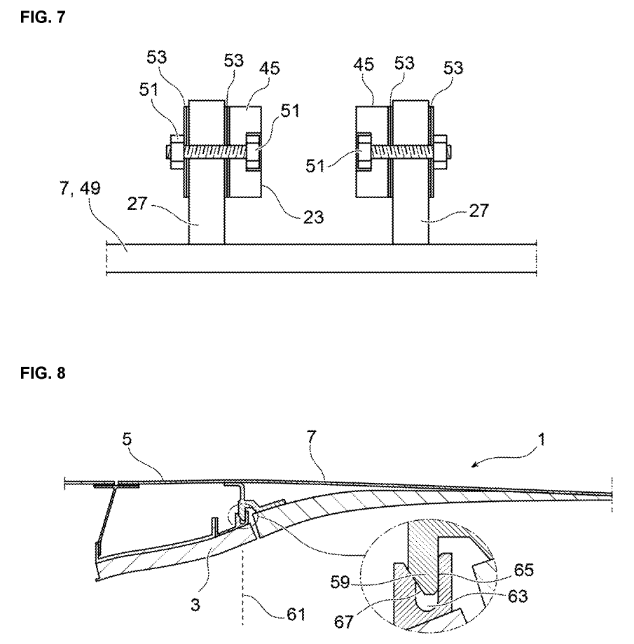

As illustrated in FIGS. 6 and 7, the propulsion unit 1 further comprises, for each cowl 7, a shim device 53 configured to be inserted between the finger 21 and the pylon 11 and/or between the sleeve 23 and the corresponding cowl 7.

The shim device 53 is configured to adjust the position of the finger 21 or the sleeve 23 along the longitudinal axis 17.

It is thus possible to displace the finger 21 or the sleeve 23 along the longitudinal axis 17 so as to align them according to the existing functional clearances between the turbomachine 3, the nacelle 5, and the cowl 7.

According to one possibility, illustrated in FIG. 6, for each cowl 7, the shim device 53 comprises a ridged shim 55 configured to be mounted on the pylon 11, the ridged shim 55 having a plurality of ridges positioned normally to the longitudinal axis 17 so as to allow cooperation with the finger 21 or the sleeve 23 in a plurality of axially adjusted positions. FIG. 6 is a side cross-sectional view allowing to show a rivet or screw-type fastener 51.

This arrangement allows the axial position of the finger 21 and/or the sleeve 23 to be adjusted by offsetting one or more ridges to provide proper alignment of the finger 21 and the sleeve 23 in the maintenance position.

As illustrated in FIG. 7, the shim device 53 can also comprise a plurality of interchangeable shims 57 suitable for being positioned on either side of a mounting support of the sleeve 23 to the pylon 11 or the corresponding cowl 7. The interchangeable shims 57 are configured to be arranged in varying quantities on either side of the mounting support to adjust the position of the sleeve 23 along the longitudinal axis.

For example, the mounting support can be the extension of the cowl 7 or the connecting element 27 to the cowl 7 to fasten the sleeve 23, in particular at two points corresponding to the two studs 45.

As illustrated in FIG. 8, each cowl 7 has a semi-circumferential tooth 59 extending in a transverse plane 61 to the corresponding longitudinal axis 17, the semi-circumferential tooth 59 being configured to cooperate with a corresponding groove 63 of the turbomachine 3 in the working position and up to a release opening angle of the cowl 7.

This arrangement allows the cowls 7 to be guided at the beginning of the opening.

The semi-circumferential tooth 59 has a downstream stop 65 extending approximately orthogonally to the corresponding longitudinal axis 17 and an upstream stop 67 extending at an angle to the downstream stop 65 so as to define a point.

The constraints on the cowl 7 during opening are directed downstream. The orthogonal downstream stop 65 thus maintains the alignment of the cowl 7 between the working position and the opening angle.

According to one possibility, the release opening angle is less than the angle of the cowl 7 in the intermediate position. In this case, the cowl 7 is free of constraint between these two opening angles.

According to another possibility, the release opening angle is greater than the angle of the cowl in the intermediate position. In this case, the cowl 7 is doubly constrained between these two opening angles. This overlap inhibits any movement of the cowl 7 along the longitudinal axis 17.

The propulsion unit 1 may also comprise, for each cowl 7, an additional blocking guide, not shown here, provided with a channel formed in a casing of the turbomachine 3 or the corresponding cowl 7 and an arm attached to the cowl 7 or the casing configured to cooperate with the channel so as to inhibit a translation of the cowl along the corresponding longitudinal axis 17 relative to the casing between a first opening angle of the cowl 7 less than the release opening angle and a second opening angle greater than an intermediate angle for the beginning of cooperation between the finger 21 and the corresponding sleeve 23.

Each cowl 7 is first maintained by the semi-circumferential tooth 59, then by the blocking guide, and finally by the longitudinal blocking mechanism 19.

The additional blocking guide is thus an axial blocking element allowing the cowls 7 to be maintained axially between the retention by the semi-circumferential tooth 59 and the retention by the longitudinal blocking mechanism 19.

Moreover, there is an overlap between these three longitudinal blocking means to inhibit any longitudinal displacement.

The longitudinal blocking mechanism 19 engages when the cowl 7 is opened at an angle of approximately 10° relative to the longitudinal axis.

It thus appears that, due to their respective locations, secured to the cowls 7 on the one hand and secured to the pylon 11 on the other hand, the fingers 21 and sleeves 23 of the longitudinal blocking mechanism 19 authorize a significant opening angle between the working position and the maintenance position.

Indeed, the length of the stroke between a cowl 7 and the pylon 11 can be defined by the radius of the circular arc 25 described by the stroke. It is therefore easy to increase the angle between the working position and the maintenance position while taking advantage of the longitudinal blocking.

This arrangement makes it possible to define the circular arc 25 at a location more or less distant from the longitudinal axis 17. It is thus possible, by the size of the finger 21 and the sleeve 23, to define the maximum opening angle of the cowls 7 in the maintenance position.

This maximum angle is thus greater than what is possible with a longitudinal blocking mechanism located at the hinge, that is to say located on the longitudinal axis. This makes the longitudinal blocking mechanism described here particularly advantageous.

As will be understood, the present disclosure is not limited to the single variation described above by way of example; on the contrary, it encompasses all forms of this variation.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A propulsion unit for aircraft comprising:
a nacelle having a cross-section provided with at least one cowl movably mounted so as to be deployed between a working position and a maintenance position in order to provide access to a turbomachine intended to be mounted in the nacelle,
a pylon adapted to fasten the turbomachine and/or the nacelle to the aircraft, the pylon comprising, for each cowl, a first hinge portion configured to cooperate with a second hinge portion of a corresponding cowl to allow pivoting of the corresponding cowl about a corresponding longitudinal axis between the working position and the maintenance position,
a longitudinal blocking mechanism comprising, for each cowl, a finger and a sleeve having two retaining portions extending transversely to the corresponding longitudinal axis, the finger being configured to be guided between the two retaining portions in the maintenance position; the finger and the sleeve being configured to describe a relative trajectory along a circular arc about the corresponding longitudinal axis between the working position and the maintenance position; the sleeve being attached to the corresponding cowl or a connecting element to the corresponding cowl and the finger being attached to the pylon, or vice versa.

2. The propulsion unit according to claim 1, wherein, for each cowl, the finger and the sleeve are configured to be spaced apart from the corresponding longitudinal axis between the working position and the maintenance position.

3. The propulsion unit according to claim 1, wherein, for each cowl, the finger and the sleeve extend at least partially in a curved manner along the relative trajectory along the circular arc about the corresponding longitudinal axis such that the finger and the sleeve interlock with each other between an intermediate position and the maintenance position.

4. The propulsion unit according to claim 1, wherein, for each cowl, the finger has, on either side transversely to the corresponding longitudinal axis and relative to a direction of airflow in the propulsion unit, an upstream cooperation face and a downstream cooperation face configured to cooperate with the sleeve, the upstream cooperation face and/or the downstream cooperation face respectively forming at one end of the finger an upstream engagement chamfer and/or a downstream engagement chamfer configured to engage the finger in the sleeve in case of offset along the corresponding longitudinal axis.

5. The propulsion unit according to claim 4, wherein, for each cowl, the sleeve has two parallel surfaces extending transversely to the corresponding longitudinal axis, the two parallel surfaces being configured to cooperate respectively with the upstream cooperation face and the downstream cooperation face.

6. The propulsion unit according to claim 1, wherein, for each cowl, the sleeve comprises two distinct studs providing an intermediate space extending along the corresponding longitudinal axis and adapted for insertion of the finger by shape complementarity.

7. The propulsion unit according to claim 1, wherein at least one cowl comprises a beam extending parallel to the corresponding longitudinal axis, the second hinge portion being attached to the beam on one side and the sleeve or the finger being attached to the beam on other side so as to be spaced apart from the second hinge portion along the corresponding longitudinal axis.

8. The propulsion unit according to claim 1, further comprising, for each cowl, a shim device configured to be inserted between the finger and the pylon and/or between the sleeve and the corresponding cowl, or vice versa: the shim device being configured to adjust a position of the finger and/or the sleeve along the corresponding longitudinal axis.

9. The propulsion unit according to claim 1, wherein at least one cowl has a semi-circumferential tooth extending in a plane transverse to the corresponding longitudinal axis, the semi-circumferential tooth being configured to cooperate with a corresponding groove of the turbomachine in the working position and up to a release opening angle of the at least one cowl.

10. The propulsion unit according to claim 9, comprising, for each cowl, an additional blocking guide provided with a channel formed in a casing of the turbomachine or the corresponding cowl and an arm attached to the corresponding cowl or the casing configured to cooperate with the channel so as to inhibit a translation of the corresponding cowl along the corresponding longitudinal axis relative to the casing between a first opening angle of the corresponding cowl less than the release opening angle and a second opening angle greater than an intermediate angle for a beginning of cooperation between the finger and the sleeve.
